(19) United States
(12) Patent Application Publication
(10) Pub. No.: US 2024/0396681 A1
(43) Pub. Date: Nov. 28, 2024

(54) REFERENCE SIGNAL RESOURCE REPORTING

(71) Applicant: QUALCOMM Incorporated, San Diego, CA (US)

(72) Inventors: Marwen Zorgui, San Diego, CA (US); Srinivas Yerramalli, San Diego, CA (US); Balwinderpal Sachdev, San Diego, CA (US)

(21) Appl. No.: 18/322,739

(22) Filed: May 24, 2023

(51) Int. Cl. H04L 5/00; G01S 5/00; G01S 5/02; H04B 7/06; H04W 64/00

(52) U.S. Cl. CPC H04L 5/0048; G01S 5/0027; G01S 5/0036; G01S 5/0242; H04B 7/0691; H04L 5/0035; H04W 64/006

(57) ABSTRACT

This disclosure provides systems, methods, and devices for wireless communication that support reference signal resource reporting. In a first aspect, a method includes receiving a first reference signal and a second reference signal of a reference signal session. The first aspect also includes transmitting, based on the first and second reference signals, information that indicates a measurement value or a location associated with an antenna array. In a second aspect, a method includes transmitting, using a first antenna element of an antenna array, a first sensing reference signal, and transmitting, using a second antenna element of the antenna array, a second sensing reference signal of the reference signal session. The second aspect also includes transmitting information that indicates a first location of the first antenna element, a second location of the second antenna element, or an equivalent location. Other aspects and features are also claimed and described.

### TECHNICAL FIELD

Aspects of the present disclosure relate generally to wireless communication systems, and more particularly, to reporting associated with a reference signal resource, such as information that is representative of a combination of multiple reference signal resources or a location associated with an antenna element used to communicate a reference signal resource. Some features may enable and provide improved communications including reduced control overhead.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

In a typical wireless communication network that includes reference signal resources, such as positioning reference signal (PRS) network resources or sounding reference signal (SRS) network resources, each reference signal is measured individually and associated with a unique location. A network entity of these typical networks provides each measurement with corresponding antenna location information, which can result in significant overhead.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication performed by a network entity includes receiving a first reference signal of a reference signal session, and receiving a second reference signal of the reference signal session. The method further includes transmitting, based on the first reference signal and the second reference signal, information that indicates a measurement value, a location associated with an antenna array, or a combination thereof.

In an additional aspect of the disclosure, a network entity includes a memory storing processor-readable code, and at least one processor coupled to the memory. The at least one processor is configured to execute the processor-readable code to cause the at least one processor to receive a first reference signal of a reference signal session, and receive a second reference signal of the reference signal session. The at least one processor is also configured to execute the processor-readable code to cause the at least one processor to transmit, based on the first reference signal and the second reference signal, information that indicates a measurement value, a location associated with an antenna array, or a combination thereof.

In an additional aspect of the disclosure, an apparatus includes means for receiving a first reference signal of a reference signal session, and means for receiving a second reference signal of the reference signal session. The apparatus also includes means for transmitting, based on the first reference signal and the second reference signal, information that indicates a measurement value, a location associated with an antenna array, or a combination thereof.

In an additional aspect of the disclosure, a non-transitory computer-readable medium stores instructions that, when executed by a processor, cause the processor to perform operations. The operations comprise receiving a first reference signal of a reference signal session, and receiving a second reference signal of the reference signal session. The operations also include transmitting, based on the first reference signal and the second reference signal, information that indicates a measurement value, a location associated with an antenna array, or a combination thereof.

In one aspect of the disclosure, a method for wireless communication performed by a network entity includes transmitting, using a first antenna element of an antenna array of the network entity, a first sensing reference signal of a reference signal session. The method further includes transmitting, using a second antenna element of the antenna array of the network entity, a second sensing reference signal of the reference signal session. The method also includes transmitting, to a network, information that indicates a first location of the first antenna element, a second location of the second antenna element, an equivalent location based on the first location or the second location, or a combination thereof.

In an additional aspect of the disclosure, a network entity includes a memory storing processor-readable code, and at least one processor coupled to the memory. The at least one processor is configured to execute the processor-readable code to cause the at least one processor to transmit, using a first antenna element of an antenna array of the network entity, a first sensing reference signal of a reference signal session. The at least one processor is further configured to execute the processor-readable code to cause the at least one processor to transmit, using a second antenna element of the antenna array of the network entity, a second sensing reference signal of the reference signal session. The at least one processor is also configured to execute the processor-readable code to cause the at least one processor to transmit, to a network, information that indicates a first location of the first antenna element, a second location of the second antenna element, an equivalent location based on the first location and the second location, or a combination thereof.

In an additional aspect of the disclosure, an apparatus includes means for transmitting. using a first antenna element of an antenna array of the network entity, a first sensing reference signal of a reference signal session. The apparatus further includes means for transmitting, using a second antenna element of the antenna array of the network entity, a second sensing reference signal of the reference signal session. The apparatus also includes means for transmitting, to a network, information that indicates a first location of the first antenna element, a second location of the second antenna element, an equivalent location based on the first location and the second location, or a combination thereof.

In an additional aspect of the disclosure, a non-transitory computer-readable medium stores instructions that, when executed by a processor, cause the processor to perform operations. The operations comprise transmitting, using a first antenna element of an antenna array of the network entity, a first sensing reference signal of a reference signal session, and transmitting, using a second antenna element of the antenna array of the network entity, a second sensing reference signal of the reference signal session. The operations further comprise transmitting, to a network, information that indicates a first location of the first antenna element, a second location of the second antenna element, an equivalent location based on the first location and the second location, or a combination thereof.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports reference signal resource reporting according to one or more aspects.

FIG. 5 is a flow diagram illustrating an example process that supports reference signal resource reporting according to one or more aspects.

FIG. 6 is a flow diagram illustrating an example process that supports reference signal resource reporting according to one or more aspects.

FIG. 7 is a block diagram of an example network that supports reference signal resource reporting according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support reference signal resource reporting. For example, the present disclosure describes techniques for a network entity (e.g., a user equipment (UE) or a base station) to determine a measurement based on multiple reference signals, such a multiple positioning reference signals (PRSs) or multiple sensing reference signals (SRSs). The multiple reference signals may be transmitted from multiple antennas of a second network entity and may be received by the network entity. The network entity may then report the determined measurement to a second network entity or a network, such as a management function of a core network. The techniques may further include the network entity providing location information associated with the determined measurement. For example, the network entity may report to the second network entity or core network a list of reference signal resources that were used for determining the measurement. Each reference signal resource of a wireless network is associated with a unique location. In another example, the network entity may determine an effective antenna location of the second network entity (e.g., a transmitting entity) or of the network entity (e.g., a receiving entity). The network entity may report the effective antenna location to the second network entity. Additionally, or alternatively, the second network entity may determine an effective antenna location of the second network entity (e.g., a transmitting entity). In some implementations, the network entity may determine a dataset of possible effective antenna locations, with identifiers for each possible effective antenna location, and provide the dataset to the second network entity or to the core network prior to determining the determined measurement. In some such implementations, the network entity may determine the effective antenna location, and may report the identifier, such as an index value, associated with the determined effective antenna location to the second network entity or to the core network to enable the second network entity or the core network to identify the effective antenna location in the dataset.

Particular implementations of the subject matter described in this disclosure may be implemented to realize one or more of the following potential advantages or benefits. In some aspects, the present disclosure provides techniques for supporting reference signal resource reporting. For example, the techniques may support determining a measurement representative of a value measured by a combination of multiple reference signal resources. The techniques described may also enable various functions of a wireless network to be performed by determining the combined channel measurement, such as functions associated with location and radio frequency (RF) sensing. For example, channel measurements may be combined for performing angle estimation or computing range, angle, or Doppler information, among other examples. The techniques described may also reduce the overhead of a wireless network by reducing the amount of data that must be transmitted between network entities as a result of the combined measurement or effective antenna location reporting.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology.

Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHZ, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

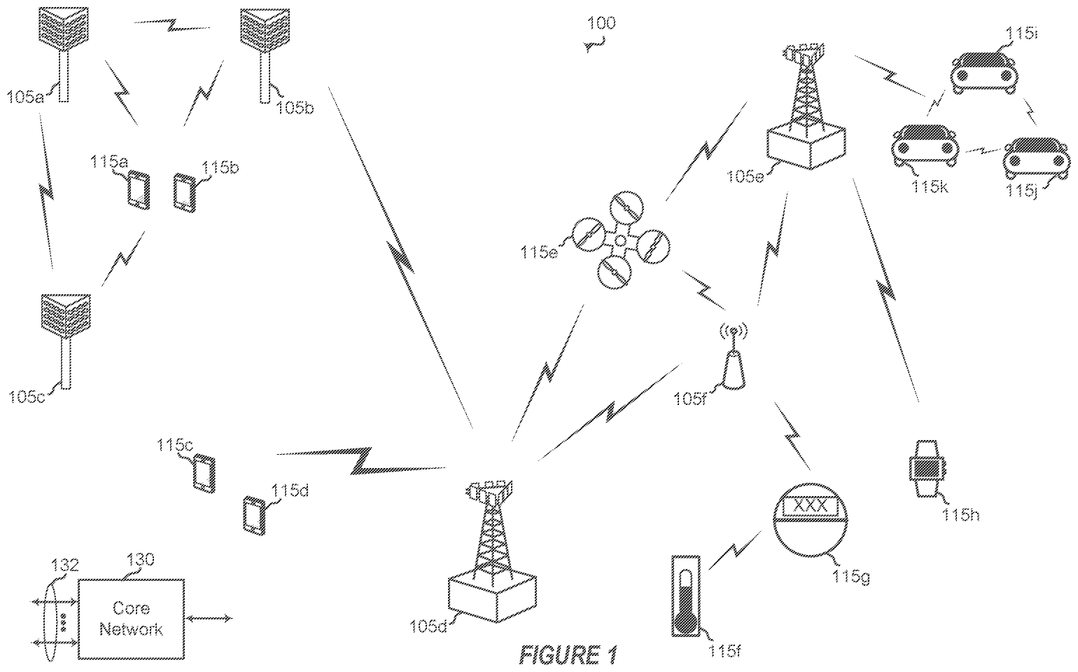

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115c-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c.

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a management function, such as a Location Management Function (LMF) or or a Sensing Management Function (SnMF), which is an entity in the 5G Core Network (5GC) supporting various functionality, such as managing support for different location services for one or more UEs. The SnMF may be configured to manage support for sensing operations for one or more sensing operations or sensing services for one or more devices, such as one or more UEs 115, one or more base stations 105, one or more TRPs, or a combination thereof. For example the SnMF may include one or more servers, such as multiple distributed servers. Base stations 105 may forward sensing messages to the SnMF and may communicate with the SnMF via a NR Positioning Protocol A (NRPPa). The SnMF is configured to control sensing parameters for UEs 115 and the SnMF can provide information to the base stations 105 and UE 115 so that action can be taken at UE 115, base station 105, or another device. The LMF may include one or more servers, such as multiple distributed servers. Base stations 105 may forward location messages to the LMF and may communicate with the LMF via a NR Positioning Protocol A (NRPPa). The LMF is configured to control the positioning parameters for UEs 115 and the LMF can provide information to the base stations 105 and UE 115 so that action can be taken at UE 115. In some implementations, UE 115 and base station 105 are configured to communicate with the LMF via an Access and Mobility Management Function (AMF).

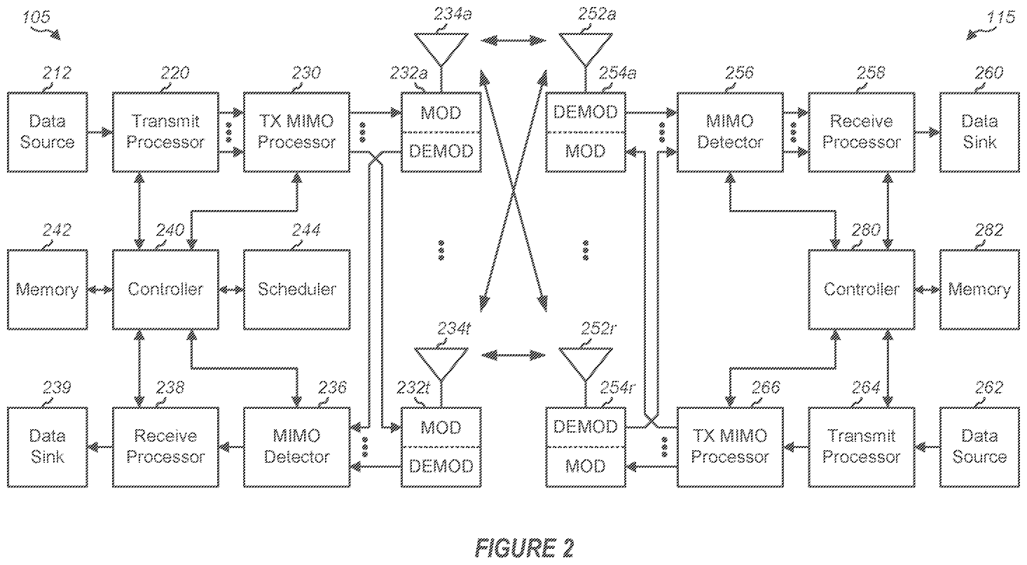

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

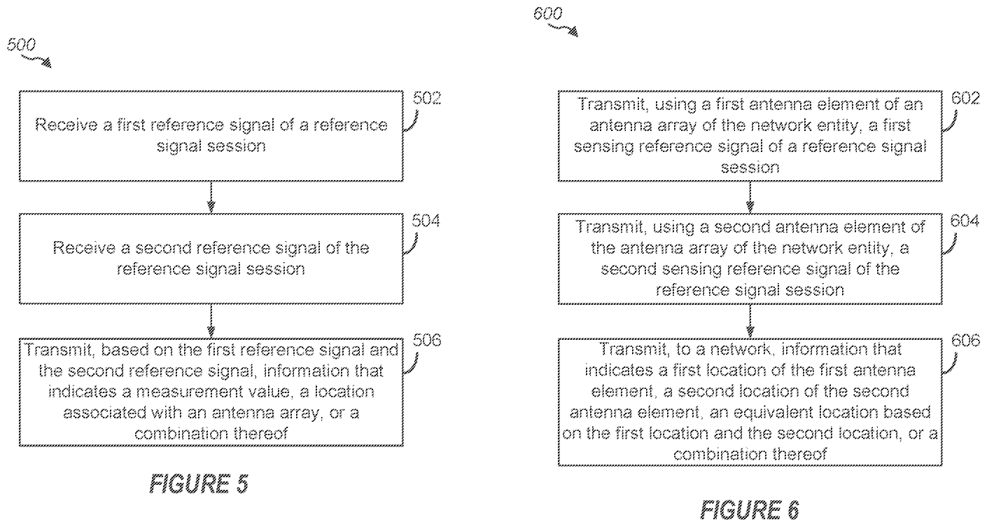

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 5 and 6, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

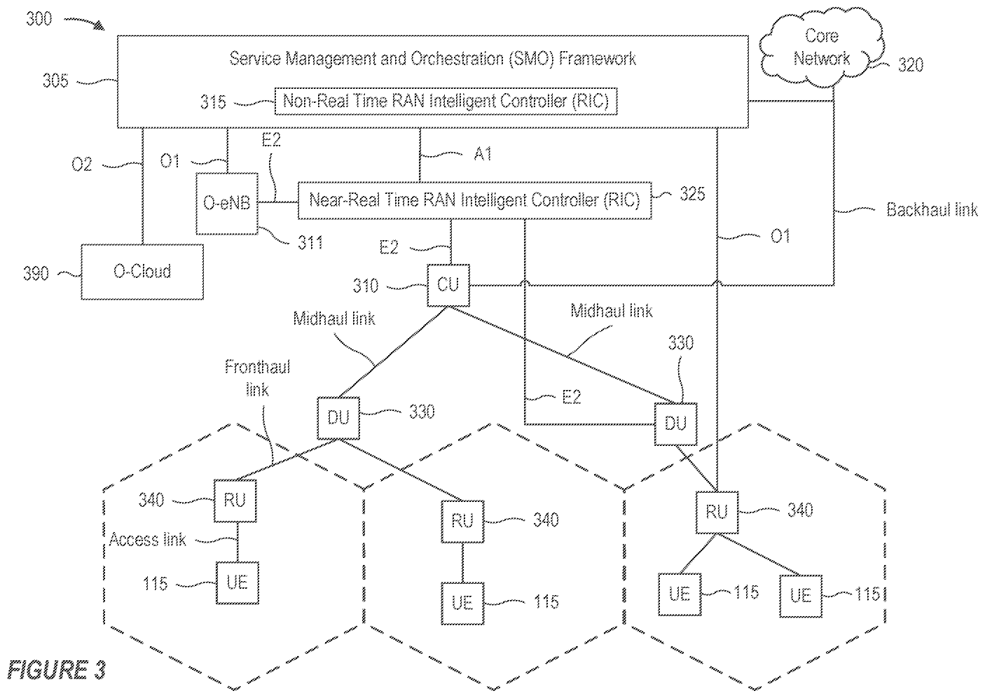

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUS 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

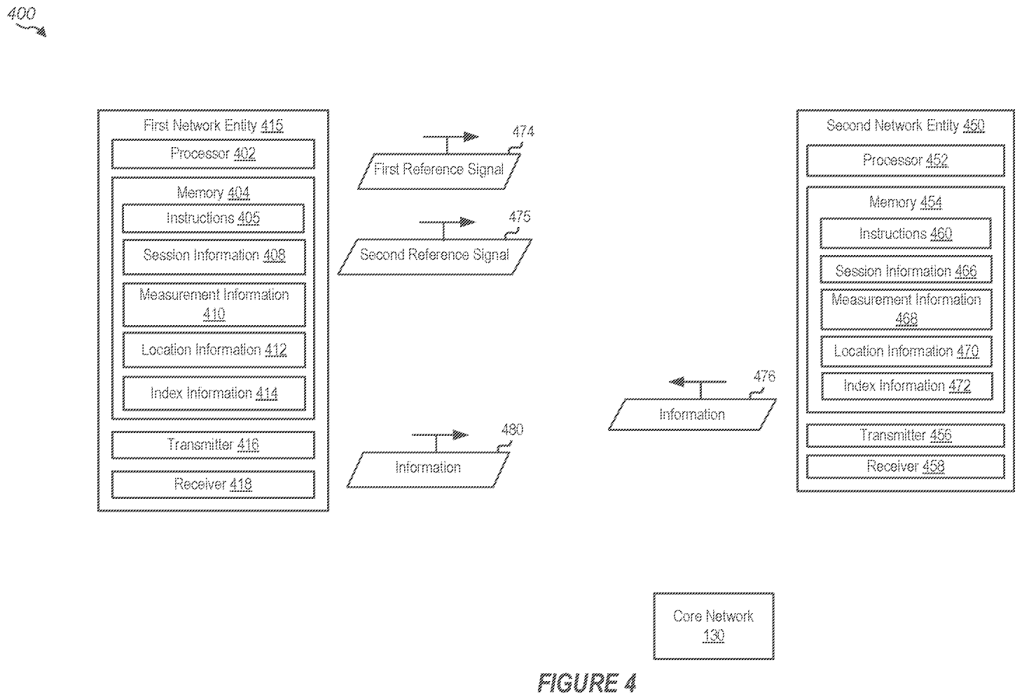

FIG. 4 is a block diagram of an example wireless communications system 400 that supports reference signal resource reporting according to one or more aspects. In some examples, wireless communications system 400 may implement aspects of wireless network 100. Wireless communications system 400 includes a first network entity 415, a second network entity 405, and core network 130. Although two network entities (e.g., 405 and 450) are illustrated, in some other implementations, wireless communications system 400 may generally include more than two network entities. First network entity 415 and second network entity 450 may include or correspond to UE 115, base station 105, a transmission and reception point (TRP), or another device.

First network entity 415 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 416 (hereinafter referred to collectively as “transmitter 416”), and one or more receivers 418 (hereinafter referred to collectively as “receiver 418”). In some implementations, first network entity 415 may include an interface (e.g., a communication interface) that includes transmitter 416, receiver 418, or a combination thereof. Processor 402 may be configured to execute instructions 405 stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store instructions 405, session information 405, measurement information 410, location information 412, and index information 414. Although memory 404 is described as including each of instructions 405, session information 405, measurement information 410, location information 412, and index information 414, in other implementations, memory 404 may not include one or more of instructions 405, session information 405, measurement information 410, location information 412, or index information 414. As an illustrative, non-limiting example, in some such implementations, memory 404 may not include index information 414. Instructions 405 may include processor-readable code, program code, one or more software instructions, or the like, as illustrative, non-limiting examples.

Session information 408 may include or indicate a configuration for a reference signal session, a technique to be used to generate measurement information 410, or a combination thereof. For example, session information 408, such as the configuration, may indicate whether the reference signal session is a radio frequency (RF) sensing session or a positioning session. In some implementations, session information 408 may indicate one or more devices, such as first network entity 415, second network entity 450, or both, to participate in the reference signal session. Additionally, or alternatively, session information 408 may indicate a parameter of a reference signal. The parameter may include a frequency, a bandwidth, a reference signal ID (e.g., a PRS ID), a transmission time, a transmit power, or a combination thereof, as one or more illustrative, non-limiting example. In some implementations, the configuration may indicate a type of measurement to be reported based on performance of the reference signal session, the technique to be used to generate measurement information 410, or a combination thereof. The technique may include an average, a minimum, a maximum, a mode, a weighted value, or a combination thereof, as illustrative, non-limiting examples.

Measurement information 410 includes or indicates a measurement determined based on a reference signal or information that corresponds to the measurement, as illustrative, non-limiting examples. In some aspects, measurement information 410 may include an individual channel measurement of a reference signal. Additionally, or alternatively, measurement information may include a measurement value that is determined or calculated based on multiple reference signal measurements. For example, the measurement value may be generated based on the technique indicate indicated by session information 408, for the type of measurement to be reported as indicated by session information 408, or a combination thereof. To illustrate, the measurement value may be a mean, median, mode, maximum, minimum, or weighted combination of the channel measurements, or another suitable method of determining a value representative of a group of values may be used to determine a measurement value. In some implementations, measurement information 410 may include or indicates, for or based on one or reference signals or a combination of multiple reference signals, a range (e.g., a timing, a distance, a round trip time (RTT), a time of arrival (TOA), a time difference of arrival (TDOA), an angle (e.g., an angle of departure (AoD), an angle of arrival (AoA), a beam angle), a Doppler information (e.g., a Doppler frequency, a Doppler frequency change rate, a Doppler map), a signal to interference noise ratio (SINR), a reference signal received power (RSRP), reference signal received quality (RSRQ), a reference signal time difference (RSTD), or a combination thereof. To illustrate, when session information 408 indicates the RF session, measurement information 410 may include or indicate a range, an angle a Doppler map, or a combination thereof. When session information 408 indicates the positioning session, measurement information 410 may include or indicate an angle of arrival (AoA), a reference signal time difference (RSTD), a reference signal received power (RSRP), a reference signal received quality (RSRQ), or a combination thereof.

Location information 412 may include or indicate a location associated with a network entity, such as a location associated with first network entity 415 or second network entity 450. In some implementation, location information 412 include or indicates a location of or associated with one or more antenna elements of first network entity 415 or second network entity 450. The location may be a location of an individual antenna element, such as a transmit antenna element or a receive transmit antenna element, within an array of antenna elements. Additionally, or alternatively, the location may be a location of or associated with a set of multiple antenna elements, such as a location of a single antenna element of the set of multiple antenna elements, a location of two or more antenna elements of the set of multiple antenna elements, an effective location of the set of multiple antenna elements, or a combination thereof. The location may include or indicate an index value, a two dimensional coordinate, a three dimensional coordinate, a position with respect to a reference location, or a combination thereof.

Index information 414 includes or indicates an index value associated location information 412. In some implementations, index information 414 includes or is indicative of a table of possible combinations of reference signal sources or effective antenna locations of first network entity 415, second network entity 450, or a combination thereof.

Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, second network entity 505. In some implementations, transmitter 416 and receiver 418 may be integrated in one or more transceivers. Additionally or alternatively, transmitter 416 or receiver 418 may include or correspond to one or more components of UE 115 or base station 105 described with reference to FIG. 2.

In some implementations, first network entity 415 may include one or more antenna arrays. The one or more antenna arrays may be coupled to transmitter 416, receiver 418, or a communication interface. The antenna array may include multiple antenna elements configured to perform wireless communications with other devices, such as with UE 115, base station 105, or second network entity 405. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of first network entity 415. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Second network entity 405 may include a variety of components (such as structural, hardware components) used for carrying out one or more functions described herein. For example, these components may include one or more processors 452 (hereinafter referred to collectively as “processor 452”), one or more memory devices 454 (hereinafter referred to collectively as “memory 454”), one or more transmitters 456 (hereinafter referred to collectively as “transmitter 456”), and one or more receivers 458 (hereinafter referred to collectively as “receiver 458”). In some implementations, second network entity 405 may include an interface (e.g., a communication interface) that includes transmitter 456, receiver 458, or a combination thereof. Processor 452 may be configured to execute instructions 460 stored in memory 454 to perform the operations described herein. In some implementations, processor 452 includes or corresponds to one or more of receive processor 238, transmit processor 220, and controller 240, and memory 454 includes or corresponds to memory 242.

Memory 454 includes or is configured to store instructions 460, session information 466, measurement information 468, location information 470, and index information 472. Instructions 460 may include processor-readable code, program code, one or more software instructions, or the like, as illustrative, non-limiting examples. Session information 466 may include or correspond to session information 408. Measurement information 468 may include or correspond to measurement information 410. Location information 470 may include or correspond to location information 470. Index information 472 may include or correspond to index information 414.

Transmitter 456 is configured to transmit reference signals, synchronization signals, control information and data to one or more other devices, and receiver 458 is configured to receive reference signals, control information and data from one or more other devices. For example, transmitter 456 may transmit signaling, control information and data to, and receiver 458 may receive signaling, control information and data from, first network entity 415. In some implementations, transmitter 456 and receiver 458 may be integrated in one or more transceivers. Additionally or alternatively, transmitter 456 or receiver 458 may include or correspond to one or more components of UE 115 or base station 105 described with reference to FIG. 2.

In some implementations, second network entity 405 may include one or more antenna arrays. The antenna array may include multiple antenna elements configured to perform wireless communications with other devices, such as with UE 115, base station 105, or first network entity 415. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams.

Alternatively, one or more sets of antenna elements of the antenna array may be configured to concurrently generate multiple beams, for example using multiple RF chains of second network entity 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, wireless communications system 400 implements a 5G NR network. For example, wireless communications system 400 may include one or more 5G-capable UEs 115, one or more 5G-capable base stations 105, or one or more 5G-capable network entities 415 or 415, such as one or more devices configured to operate in accordance with a 5G NR network protocol such as that defined by the 3GPP. In some other implementations, wireless communications system 400 implements a 6G network. In some implementations, first network entity 415 or second network entity 405 is a 5G-capable network entity, a 6G-capable network entity, or a combination thereof. Additionally, or alternatively, in some implementations, first network entity 415 may be configured to perform one or more operations as described with reference to second network entity 450, and vice versa.

In some implementations, a network entity (e.g., 415 or 450) may combine refence signals, or measurements associated with the reference signal, associated with multiple antenna elements. For example, if the network entity is configured to perform a positioning session (based on session information 408), the network entity may combine PRS transmissions transmitted from multiple antenna elements determine a measurement, such as measurement information 410. For example, the measurement may include an angle (e.g., an estimated angle), a range, or a Doppler value. Stated differently, the network entity may combine transmissions from one or more PRS resources, such as one or more PRS transmission resource.

In some implementations, the network entity (e.g., 415 or 450) may combine channel measurements (e.g., 410) associated with multiple PRS resources. For example, the network entity may combine the channel measurements to determine or report one or more parameters (e.g., measurement information 410) of a combined channel. To illustrate, the network entity may report the channel measurements or the combined channel measurements (e.g., the one or more parameters) to another network entity or the network, such as core network 130. It is noted that the reporting of the combined channel measurements need not indicate how (e.g., a technique) multiple channel measurements were combined. Additionally, or alternatively, the network (e.g., 130) need not be informed as to how the combining was performed.

In some implementations, the network entity (e.g., 415 or 450) may combine measurements, such as channel measurements, that are based on reference signals transmitted from a subset of antenna elements, such as a subset of Tx antenna elements. In some such implementations, the network entity may report each PRS resource (or antenna elements) used to determine the combined measurement. Additionally, or alternatively, the network entity may determine an effective antenna location (of a Tx antenna) by combining the antenna locations for each PRS resource used for determining the combined measurement. The network entity may report the effective location (e.g., 412) to the other network entity or to the network. As an illustrative example, the network entity measures five PRS resources, and each PRS resource has a location. The location of each PRS resource may be referred to as an antenna reference point (ARP). The network entity may determine the effective location by determining an average of the five ARPs. When the network entity reports the combined measurement that is based on the five PRS resources, the report may indicate the average ARP location as an equivalent location.

In some implementations, the network entity (e.g., 415 or 450) may combine measurements, such as channel measurements, that are based on the reference signals received using multiple Rx antenna elements. In some such implementations, the network entity may determine an effective location of the Rx antenna elements that is associated with the combined measurement. The network entity may report the effective location of the Rx antenna elements to the other network entity or to the network.

In some implementations, the network entity (e.g., 415 or 450) is configured to a sensing session (based on session information 408), such as an RF sensing session. In some such implementations, the network entity is configured to transmit one or more references signals, such as one or more SRS resources or one or more SRSs. For example, the network entity may transmit an SRS resource using more than one antenna and the network entity can determine an equivalent SRS Tx location. The network entity may report the equivalent SRS Tx location to another network entity or to the network (e.g., core network 130), such as a sensing management function of core network 130 or a location management function of core network 130. To illustrate, the network entity may determine or report the equivalent SRS Tx location with respect to a reference location on or associated with the network entity. Additionally, or alternatively, in some implementations, the network entity is configured to receive one or more references signals, such as one or more SRS resources or one or more SRSs. For example, the network entity may receive an SRS resource using more than one antenna and the network entity can determine an equivalent Rx location. The network entity may report the equivalent Rx location to another network entity or to the network (e.g., core network 130), such as a sensing management function of core network 130 or a location management function of core network 130. To illustrate, the network entity may determine or report the equivalent Rx location with respect to a reference location on or associated with the network entity.

In some implementations, for a sensing session (based on session information 408), such as an RF sensing session, the network entity (e.g., 415 or 450) may include a TRP and may be configured to perform an inter-TRP sensing operation. The inter-TRP sensing operation may include a sensing operation between two TRPs where a first TRP (e.g., the network entity) transmits an SRS and a second TRP (e.g., another network entity) receives a reflection of the SRS. In such implementations, the core network may receive a report, from the first or second TRPs, that indicates an effective Rx location, an effective Tx location, or a combination thereof, for each measurement.

In some implementations, the network entity (e.g., 415 or 450) may include index information 414 or 472. For example, the network entity may be preconfigured with the index information 414 or 472 or may receive index information 414 or 472 from another network entity or the network (e.g., 130). Additionally, or alternatively, the network entity may provide index information 414 or 472 to core network 130, such as to a sensing management function of core network 130 or a location management function of core network 130. Index information 414 or 472 may include or indicate one or more effect Rx locations, one or more effective Tx locations, or a combination thereof. For a measurement reported by the network entity, the network entity may include or indicate an index value (e.g., 414 or 472) that correspond to an effective Tx location or an effective Rx location.

To further illustrate, the network entity may perform multiple measurements or provide multiple reports. For example, the network entity may need to periodically report or frequently report one or more measurements. In such situations, the network entity may receive or provide index information 414 or 472 which includes or indicates a list of possible effective or equivalent here Rx location and or a list of effective Tx locations. To illustrate, a first index value may correspond to a first Rx antenna element location, a second index value may correspond to a second Rx antenna element location, and a third index value may correspond to an effective location of a combination of the first and second antenna element locations. The network entity may share the index information with the LMF or the SnMF of core network 130. For example, the network entity may share the index information prior to or at the beginning of a reference signal session. Accordingly, the network entity knows what kind of possible effective combinations based on a received combination of antenna PRS resource IDs, or SRS resource IDs and antennas. For a given measurement determine by the network entity, one effective Tx location or Rx location will be applicable. The network entity may provide a report that includes measurement information 410 and an index value (of index information 414 or 472). By reporting the index value, overhead may be reduced as compared to reporting each location corresponding to the index value.

During operation of wireless communications system 400, first network entity 415 may transmit a first reference signal 474 and a second reference signal 475 to second network entity 450. For example, first reference signal 474 and second reference signal 475 may be transmitted via the same channel or different channels. In some implementations, first reference signal 474 may be transmitted using a first set of one or more Tx antenna elements, such as one or more antenna elements of transmitter 416. Additionally, or alternatively, second reference signal 474 may be transmitted using a second set of one or more Tx antenna elements, such as one or more antenna elements of transmitter 416. The first set of one or more Tx antenna elements and the second set of one or more Tx antenna elements may be the same set or different sets.

In some implementations, first network entity 415 may generate information 480 that is transmitted to second network entity 450 or to core network 130, such as an LMF or SnMF of core network 130. Information 480 may include or indicate a first Tx location of the first set of one or more Tx antenna elements, a second Tx location of the second set of one or more Tx antenna elements, or a combination thereof. Additionally, or alternatively, information 480 may include or indicate an effective Tx location of a combination of the first set of one or more Tx antenna elements, the second set of one or more Tx antenna elements. The first Tx location, the second Tx location, the effective Tx location, or a combination thereof may include or correspond to location information 412. To indicate the first Tx location, the second Tx location, the effective Tx location, or a combination thereof, information 480 may include an index value, such as an index value based on index information 414.

Second network entity 450 may receive first reference signal 474 using a first set of one or more Rx antenna elements, such as one or more antenna elements of receiver 458. Additionally, or alternatively, second network entity 450 may receive second reference signal 475 using a second set of one or more Rx antenna elements, such as one or more antenna elements of receiver 458. The first set of one or more Rx antenna elements and the second set of one or more Rx antenna elements may be the same set or different sets.

Second network entity 450 may generate a first measurement based on first reference signal 474. Additionally, or alternatively, second network entity 450 may generate a second measurement based on second reference signal 475. In some implementations, second network entity 450 may determine a combined measurement based on the first measurement and the second measurement. The first measurement, the second measurement, the combined measurement, or a combination thereof may include or correspond to measurement information 468.

In some implementations, second network entity 450 may generate information 476 that is transmitted to first network entity 415 or to core network 130, such as an LMF or SnMF of core network 130. Information 476 may include or indicate a first Tx location of the first set of one or more Tx antenna elements, a second Tx location of the second set of one or more Tx antenna elements, or a combination thereof. Additionally, or alternatively, information 476 may include or indicate an effective Tx location of a combination of the first set of one or more Tx antenna elements, the second set of one or more Tx antenna elements. The first Tx location, the second Tx location, the effective Tx location, or a combination thereof may include or correspond to location information 470.

Additionally, or alternatively, information 476 may include or indicate a first Rx location of the first set of one or more Rx antenna elements, a second Rx location of the second set of one or more Rx antenna elements, or a combination thereof. Additionally, or alternatively, information 476 may include or indicate an effective Rx location of a combination of the first set of one or more Rx antenna elements, the second set of one or more Rx antenna elements. The first Rx location, the second Rx location, the effective Rx location, or a combination thereof may include or correspond to location information 470. To indicate the first Rx location, the second Rx location, the effective Rx location, or a combination thereof, information may include an index value, such as an index value based on index information 472.

In some implementations, information 476 may include or indicate a measurement, a location, or a combination thereof. For example, information 476 may include the first measurement, the first Tx location, the first Rx location, or a combination thereof. Additionally, or alternatively, information 476 may include the second measurement, the second Tx location, the second Rx location, or a combination thereof. Additionally, or alternatively, information may include or indicate the combined measurement, the effective Tx location, the effective Rx location, or a combination thereof. In some implementations, information 476 may include, the combined measurement, the first Tx location, the second Tx location, the effective Tx location, the first Rx location, the second Rx location, the effective Rx location, or a combination thereof.

In some implementations, to indicate the first Tx location, the second Tx location, the effective Tx location, the first Rx location, the second Rx location, the effective Rx location, or a combination thereof, information 476 may include an index value. For example, the index value may be based on index information 414.

In some implementations, prior to or at the beginning of a reference signal session, first network entity 415 or second network entity 450 may receive a configuration that indicates a type of the reference signal session, one or more parameters of the reference signal session, or a combination thereof. The configuration may include or correspond to session information 408 or 466. The type of the reference signal session may be a positioning session or a sensing session, such as an RF sensing session. When the type is the positioning session, each of first reference signal 474 and second reference signal is a positioning reference signal. Alternatively, when the type is the sensing session, each of first reference signal 474 and second reference signal is a sensing reference signal.

In some implementations, prior to or at the beginning of a reference signal session, first network entity 415 or second network entity 450 may transmit or receive index information, such as index information 414 or 472. To illustrate, first network entity 415 may transmit index information 414 to second network entity 450, core network 130, or a combination thereof. As another example, second network 450 may transmit index information 472 to first network entity 415, core network 130, or a combination thereof.

In some implementations, a network entity (e.g., 415 or 450) may determine an effective antenna location. As an illustrative, non-limiting example, first network entity 415, such as UE 115, may include two antenna transmitter arrays, one of which is H-polarized (Tx-H) and the other of which is V-polarized (Tx-V). Tx-H has location coordinates of

[−5.2241, 2.7313, 0.35] (e.g., [x coordinate, y coordinate, z coordinate]) and Tx-V has location coordinates of [−5.3004, 2.6394, 0.35]. Second network entity 450 may include two antenna receiver arrays, one of which is H-polarized (Rx-H) and the other of which is V-polarized (Rx-V). Rx-H has location coordinates of [−5.6115, 2.2657, 0.35] and Rx-V has location coordinates of [−5.6880, 2.1741, 0.35]. The coordinates of Tx-V, Tx-H, Rx-V, Rx-H, or a combination thereof, may include or correspond to location information 412 or 470. Based on these antenna arrays, there are four possible links in this example, which are from TxV to RxV; TxV to RxH; TxH to RxV; and TxH to RxH.

In a first transmission of one or more reference signals (e.g., 474 or 475) by first network entity 415, the link TxV to RxV measured a value of 13.14 meters (e.g., measurement information 410), and the links TxV to RxH, TxH to RxV, and TxH to RxH did not measure anything. Second network entity 450 may determine a Tx location, such as an equivalent Tx location that is equal to Tx-V location of [−5.3004, 2.6394, 0.35], an Rx location, such as an equivalent Rx location that is equal to Rx-V location of [−5.3004, 2.6394, 0.35], or a combination thereof. Second network entity 450 may include or indicate, in information 476, the value, the Tx location, the Rx location, or a combination thereof.

In second transmission of one or more reference signals (e.g., 474 or 475) by first network entity 415, the link TxV to RxV measured a value of 13.14 meters (e.g., measurement information 410), the link TxV to RxH did not measure anything, the link RxH to RxV measured a value of 13.27 meters (e.g., measurement information 410), and the link TxH to RxH did not measure anything. The two channel measurements are associated with respective reference signal resources that measured the channel measurements. In this example, the measurement is based on two individual channel measurements. One of the suitable methods described above may be used to combine the two channel measurements, such as by determining a mean of the two channel measurements, which is 13.205 meters. An effective antenna location is determined for the two different transmitter antenna arrays that were used in the measurements. Using a mean of the location coordinates of TxV and TxH as the example combination, the effective antenna location for the transmitter arrays is determined to be [−5.688, 2.1741, 0.35]. Both individual measurements were determined using RxV, accordingly, the Rx location (e.g., the equivalent RX location) of the combined measurement of 13.205 is [−5.6880, 2.1741, 0.35]. The locations of the two different transmitter antenna arrays are associated with the respective reference signal resources that measured the channel measurements. Additionally, the effective antenna location is associated with the combined measurement. Second network entity 450 may include or indicate, in information 476, the value of 13.14 meters, the value of 13.27 meters, the combined value of 13.205 meters, the Tx location (e.g., TxV. TxH, or the effective Tx location), the RxV location, or a combination thereof.

As described with reference to FIG. 4, the present disclosure provides techniques for supporting determining a measurement representative of a value measured by a combination of multiple reference signal resources. The techniques described enable various functions of a wireless network to be performed by determining the measurement, such as functions associated with location and radio frequency (RF) sensing. For example, channel measurements may need to be combined for performing angle estimation or computing range, angle, or Doppler maps, among other examples. The techniques described also reduce the overhead of a wireless network by reducing the amount of data that must be transmitted between network entities as a result of the combined measurement and/or effective antenna location reporting. The overhead can be reduced further, in some aspects, by transmitting index information that can be used to look up information in a pre-stored look-up table.

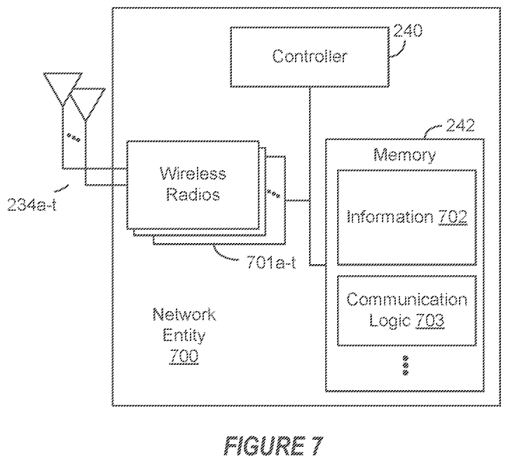

FIG. 5 is a flow diagram illustrating an example process 500 that supports reference signal resource reporting according to one or more aspects. Operations of process 500 may be performed by a network entity, such as UE 115 or base station 105 described above with reference to FIGS. 1-3, network entity 405 or 415, or a network entity as described with reference to FIG. 7. For example, example operations (also referred to as “blocks”) of process 500 may enable the network entity to support reference signal resource reporting.

In block 502, the network entity receives a first reference signal of a reference signal session. For example, the network entity may include or correspond to second network entity 450. To illustrate, the network entity may include or correspond to a UE (e.g., 115) or a first TRP. The first reference signal may include or correspond to first reference signal 474. In some implementations, the network entity may receive the first reference signal 474 from first network entity 415. The reference signal session may include or correspond to a positioning session or a sensing session, such as an RF sensing session. In some implementations, a type of the reference signal session or one or more parameters of the reference signal session may be included in or indicated by session information 408 or 466.

In block 504, the network entity receives a second reference signal of the reference signal session. For example, the second reference signal may include or correspond to second reference signal 475. In some implementations, the network entity may receive the first reference signal 475 from first network entity 415.

In block 506, the network entity transmits, based on the first reference signal and the second reference signal, information that indicates a measurement value, a location associated with an antenna array, or a combination thereof. For example, the information may include or correspond to information 476. The measurement value may include or correspond to measurement information 468. The location may include or correspond to location information 470. In some implementations, the antenna array include or corresponds to an antenna array (e.g., transmitter 416, receiver 418, or a combination thereof) of first network entity or an antenna array (e.g., transmitter 456, receiver 458, or a combination thereof) of second network entity 450. Additionally, or alternatively, in some implementations, the information (e.g., 476) includes or indicates the measurement value and the location. The network entity may transmit the information to another device, such as another network entity (e.g., 415), to a network (e.g., core network 130), or a combination thereof.

In some implementations, the reference signal session includes a positioning session. The positioning session may be associated with or indicated by session information 466. In some such implementations, the first reference signal includes a first positioning reference signal from a first antenna element of another network entity. The other network entity may include or correspond to first network entity 415. To further illustrate, the first antenna element may include or correspond to an antenna element included in transmitter 416. In some implementations, the first positioning reference signal is associated with a first positioning reference signal ID that indicates a first location, such as a first location on or in the antenna array that includes the first antenna element. In some implementations, the network entity includes a first transmission and reception point, and the other network entity includes a second transmission and reception point. Additionally, or alternatively, the second reference signal includes a second positioning reference signal from a second antenna element of the other network entity. To illustrate, the second antenna element may include or correspond to an antenna element included in transmitter 416. In some implementations, the second positioning reference signal is associated with a second positioning reference signal ID that indicates a second location, such as a second location on or in the antenna array that includes the second antenna element.

In some implementations, the network entity measures a channel to generate a first measurement value. The first measurement value may be associated with the first reference signal. The network entity may store the first measurement value or an indicator of the first measurement value at memory 404 (e.g., measurement information 410). Additionally, or alternatively, the network entity measures a channel to generate a second measurement value. The second measurement value may be associated with the second reference signal. The network entity may store the second measurement value or an indicator of the first measurement value at memory 454 (e.g., measurement information 468). In some implementations, the network entity generates the measurement value based on the first measurement value and the second measurement value. The measurement value may include or indicate a range (e.g., a distance, a timing, a round trip time (RTT), a time of arrival (TOA), a time difference of arrival (TDOA), an angle (e.g., an angle of arrival (AoA), a beam angle), a Doppler information (e.g., a Doppler frequency, a Doppler frequency change rate, a Doppler map), a signal to interference noise ratio (SINR), a reference signal received power (RSRP), reference signal received quality (RSRQ), a reference signal time difference (RSTD), or a combination thereof. In some implementations, the information indicates the measurement value. In some such implementations, the information may indicate a technique used to generate the measurement value, such as the measurement value determined based on the first reference signal and the second reference signal. The technique used to generate the measurement value may be determined or selected based on session information 466. Additionally, or alternatively, the information may indicate which reference signals that the measurement value is determined based on, such as the first reference signal, the second reference signal, or a combination thereof.

In some implementations, the network entity determines one or more locations, such as one or more locations associated with an antenna array. The antenna array may include an antenna array (that includes transmitter 456, receiver 458, or a combination thereof) of the network entity, or an antenna array (that includes transmitter 416, receiver 418, or a combination thereof) of another network entity (e.g., 415).

In some implementations, the one or more locations may include a first location of a first transmit antenna element of the antenna array (e.g., of first network entity 415). For example, the first transmit antenna element may be associated with transmission of the first reference signal, such as a first transmit antenna element (e.g., transmitter 416) of first network entity 415. The first location may be determined based on a reference signal ID of the first reference signal. Additionally, or alternatively, the one or more locations may include a second location of a second transmit antenna element of the antenna array. The second transit antenna element may be associated with transmission of the second reference signal, such as a first transmit antenna element (e.g., transmitter 416) of first network entity 415. The second location may be determined based on a reference signal ID of the second reference signal. The network entity may determine the location (included in or indicated by information (e.g., 476) or location information 470) based on the first location (of or associated with the first transmit antenna element), the second location (of or associated with the second transmit antenna element), or a combination thereof. In some implementations, the location includes an effective location of a transmit antenna, such as a transmit antenna (e.g., transmitter 416) of first network entity 415. For example, first network entity 415 may transmit first reference signal 474 using multiple antenna elements of a first panel (e.g., of antenna array), and the location may include an effective location associated with the first panel, such as a center of the first panel, a location of a first antenna element of the multiple antenna elements, a location of a second antenna element of the multiple antenna elements, or an average location of the locations of the multiple antenna elements used to transmit first reference signal 474.

In some implementations, the one or more locations may include a first location of a first receive antenna element of the antenna array (e.g., of second network entity 450). For example, the first receive antenna element may include or correspond to an antenna element of receiver 458 that is associated with reception of or used to receive the first reference signal (e.g., 474). Additionally, or alternatively, the one or more locations may include a second location of a second receive antenna element of the antenna array (e.g., of second network entity 450). For example, the second receive antenna element may include or correspond to an antenna element of receiver 458 that is associated with reception of or used to receive the second reference signal (e.g., 475). The network entity may determine the location (included in or indicated by information (e.g., 476) or location information 470) based on the first location (of or associated with the first receive antenna element), the second location (of or associated with the second receive antenna element), or a combination thereof. In some implementations, the location includes an effective location of a receive antenna, such as a receive antenna (e.g., receiver 418) of first network entity 415. For example, second network entity 450 may receive first reference signal 474 using multiple antenna elements of a first panel (e.g., of antenna array) or using the first panel and a second panel. Second network entity 450 may generate a measurement (e.g., a location) that is an effective Rx antenna location, such as a location of the first panel, a location of the second panel, or an average of the location of the first panel and the second panel.

In some implementations, the reference signal session includes a radio frequency (RF) sensing session. The RF sensing session may be associated with or indicated by session information 466. In some such implementations, the first reference signal includes a first sensing reference signal received from another network entity, such as first network entity 415. For example, the first reference signal may be received from a first antenna element of the other network entity. To further illustrate, the first antenna element may include or correspond to an antenna element included in transmitter 416. In some implementations, the network entity includes a first transmission and reception point, and the other network entity includes a second transmission and reception point. Additionally, or alternatively, the second reference signal may include a second sensing reference signal received from the other network entity. To illustrate, the second antenna element may include or correspond to an antenna element included in transmitter 416.

In some implementations, the network entity receives index information that indicates multiple index values. The index information may include or correspond to index information 472. The index information may be received from another network entity (e.g., 415), a network (e.g., core network 130), or a combination thereof. Each index value of the multiple index values may be associated with an effective receive (Rx) location, an effective transmit (Tx) location, or a combination thereof. In some implementations, the information (e.g., 476) includes an index value of the multiple index values that indicates the location.

FIG. 6 is a flow diagram illustrating an example process 600 that supports reference signal resource reporting according to one or more aspects. Operations of process 600 may be performed by a network entity, such as UE 115 or base station 105 described above with reference to FIGS. 1-3, network entity 405 or 415, or a network entity as described with reference to FIG. 7. For example, example operations (also referred to as “blocks”) of process 600 may enable the network entity to support reference signal resource reporting.

At block 602, the network entity transmit a first sensing reference signal of a reference signal session. The first reference signal may include or correspond to first reference signal 474. In some implementations, the network entity may transmit the first reference signal 474 to second network entity 450. The network entity may transmit the first reference signal using a first antenna element of an antenna array of the network entity. The antenna array may include or correspond to transmitter 416, receiver 418, or a combination thereof. The reference signal session may include or correspond to a sensing session, such as an RF sensing session. In some implementations, a type of the reference signal session or one or more parameters of the reference signal session may be included in or indicated by session information 408 or 466.

In block 604, the network entity transmit a second sensing reference signal of the reference signal session. For example, the second reference signal may include or correspond to second reference signal 475. In some implementations, the network entity may transmit the first reference signal 475 from first network entity 415. The network entity may transmit the second sensing reference signal using a second antenna element of the antenna array of the network entity.

In some implementations, the network entity includes a first UE (e.g., 115) or a first TRP (e.g., 105). Additionally, or alternatively, the other network entity that receives the first sensing reference signal, the second sensing reference signal, or a combination thereof, may include a second UE or a second TRP.

In block 606, the network entity transmit, to a network, information that indicates a first location of the first antenna element, a second location of the second antenna element, an equivalent location based on the first location and the second location, or a combination thereof. For example, the network may include or correspond to core network 130. The information may include or correspond to information 480. The first location and the second location, the equivalent location, or a combination there, may include or correspond to location information 412. Although the equivalent location is described as being based on both the first location and the second location, in other implementations, the equivalent location may be based on the first location or the second location. In some implementations, the network entity may additionally or alternatively transmit the information to the other network entity (e.g., 450).

In some implementations, the first location, the second location, the equivalent location, or a combination thereof, may be determined or indicated with respect to a reference location on the network entity, such as a reference location associated with or of the antenna (e.g., 416 or 418) of the network entity. In some implementations, the information (e.g., 480) indicates the first location and the second location. In some other implementation, the information (e.g., 480) indicates the equivalent location.

In some implementations, the network entity receives index information that indicates multiple index values. The index information may include or correspond to index information 414. The index information may be received from another network entity (e.g., 450), a network (e.g., core network 130), or a combination thereof. Each index value of the multiple index values may be associated with an effective receive (Rx) location, an effective transmit (Tx) location, or a combination thereof. In some implementations, the information (e.g., 480) includes an index value of the multiple index values that indicates the location.

FIG. 7 is a block diagram of an example network entity 700 that supports reference signal resource reporting according to one or more aspects. Network entity 700 may be configured to perform operations, including the blocks of a process described with reference to FIG. 6 or 7. In some implementations, network entity 700 includes the structure, hardware, and components shown and described with reference to UE 115 or base station 105 of FIGS. 1-3, or network entity 415 or 450 of FIG. 4.

For example, network entity 700 may include controller 240, which operates to execute logic or computer instructions stored in memory 242, as well as controlling the components of network entity 700 that provide the features and functionality of network entity 700. Network entity 700, under control of controller 240, transmits and receives signals via wireless radios 701a-t and antennas 234a-t. Wireless radios 701a-t include various components and hardware, as illustrated in FIG. 2 for base station 105, including modulator and demodulators 232a-t, transmit processor 220, TX MIMO processor 230, MIMO detector 236, and receive processor 238.

As another example, network entity 700 includes controller 280, which operates to execute logic or computer instructions stored in memory 282, as well as controlling the components of network entity 700 that provide the features and functionality of network entity 700. network entity 700, under control of controller 280, transmits and receives signals via wireless radios 701a-r and antennas 252a-r. Wireless radios 701a-r include various components and hardware, as illustrated in FIG. 2 for UE 115, including modulator and demodulators 254a-r, MIMO detector 256, receive processor 258, transmit processor 264, and TX MIMO processor 266.

As shown, the memory 242 may include information 702 and communication logic 703. Information 702 may include or correspond to session information 408 or 466, measurement information 410 or 468, location information 412 or 470, or index information 414 or 472. Communication logic 703 may be configured to enable communication between network entity 700 and one or more other devices. Network entity 700 may receive signals from or transmit signals to one or more UEs, such as UE 115 of FIGS. 1-3, one or more base stations, such as base station 105 of FIGS. 1-3, one or more other network entities, such as network entity 405 or 415 of FIG. 4, a TRP, or a network, such as core network 130.

It is noted that one or more blocks (or operations) described with reference to FIGS. 5 and 6 may be combined with one or more blocks (or operations) described with reference to another of the figures. For example, one or more blocks (or operations) of FIG. 5 may be combined with one or more blocks (or operations) of FIG. 6. As another example, one or more blocks associated with FIG. 5 or 6 may be combined with one or more blocks (or operations) associated with FIGS. 1-4. Additionally, or alternatively, one or more operations described above with reference to FIGS. 1-4 may be combined with one or more operations described with reference to FIG. 7.

In one or more aspects, techniques for supporting reference signal resource reporting may include additional aspects, such as any single aspect or any combination of aspects described below or in connection with one or more other processes or devices described elsewhere herein. In a first aspect, techniques for supporting determining a measurement representative of a value measured by a combination of multiple reference signal resources may include receiving a first reference signal of a reference signal session, and receiving a second reference signal of the reference signal session. The techniques may further include transmitting, based on the first reference signal and the second reference signal, information that indicates a measurement value, a location associated with an antenna array, or a combination thereof. In some examples, the techniques in the first aspect may be implemented in a method or process. In some other examples, the techniques of the first aspect may be implemented in a wireless communication device, which may include a network entity or a component of a network entity. For example, the techniques may include or correspond to a method of wireless communication performed by a network entity. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, the techniques further include the network entity includes a UE or a first TRP.

In a third aspect, in combination with the first aspect or the second aspect, the reference signal session includes a positioning session or an RF sensing session.

In a fourth aspect, in combination with one or more of the first aspect through the third aspect, the first reference signal includes a first positioning reference signal from a first antenna element of another network entity, and the second reference signal includes a second positioning reference signal from a second antenna element of the other network entity.

In a fifth aspect in combination with one or more of the first aspect through the fourth aspect, the first positioning reference signal is associated with a first positioning reference signal ID that indicates a first location, and the second positioning reference signal is associated with a second positioning reference signal ID that indicates a second location.

In a sixth aspect, in combination with one or more of the first aspect through the fifth aspect, the measurement value includes: when the reference signal session includes the RF session, a range, an angle, or a Doppler map; or when the reference signal session includes the positioning session, an angle of arrive, a reference signal time difference (RSTD), a reference signal received power (RSRP), or a reference signal received quality (RSRQ).

In a seventh aspect, in combination with one or more of the first aspect through the sixth aspect, the techniques further include measuring a channel to generate a first measurement value that is associated with the first reference signal.

In an eighth aspect, in combination with one or more of the first aspect through the seventh aspect, the techniques further include measuring the channel to generate a second measurement value that is associated with the second reference signal.

In a ninth aspect, in combination with the eighth aspect, the techniques further include generating the measurement value based on the first measurement value and the second measurement value.

In a tenth aspect, in combination with one or more of the first aspect through the ninth aspect, the information indicates the measurement value.

In an eleventh aspect, in combination with one or more of the first aspect through the tenth aspect, the information indicates a technique used to generate the measurement value based on the first reference signal and the second reference signal.

In a twelfth aspect, in combination with one or more of the first aspect through the tenth aspect, the information indicates the measurement value is based on the first reference signal and the second reference signal.

In a thirteenth aspect, in combination with one or more of the first aspect through the twelfth aspect, the techniques further include determining a first location of a first transmit antenna element of the antenna array.

In a fourteenth aspect, in combination with the thirteenth aspect, the first transmit antenna element is associated with transmission of the first reference signal.

In a fifteenth aspect, in combination with one or more of the thirteenth aspect through the fourteenth aspect, the techniques further include determining a second location of a second transmit antenna element of the antenna array.

In a sixteenth aspect, in combination with the sixteenth aspect, the second transit antenna element associated with transmission of the second reference signal.

In a seventeenth aspect, in combination with the fifteenth aspect or the sixteenth aspect, the techniques further include determining the location based on the first location, the second location, or a combination thereof, wherein the location includes an effective location of a transmit antenna.

In an eighteenth aspect, in combination with the seventeenth aspect, the information indicates the measurement value and the location.

In a nineteenth aspect, in combination with one or more of the first aspect through the eighteenth aspect, the techniques further include determining a first location of a first receive antenna element of the antenna array.

In a twentieth aspect, in combination with the nineteenth aspect, the first receive antenna element associated with reception of the first reference signal.

In a twenty-first aspect, in combination with the nineteenth aspect or the twentieth aspect, the techniques further include determining a second location of a second receive antenna element of the antenna array.

In a twenty-second aspect, in combination with the twenty-first aspect, the second antenna receive element associated with reception of the second reference signal.

In a twenty-third aspect, in combination with the twenty-first aspect or the twenty-second aspect, the techniques further include determining the location based on the first location, the second location, or a combination thereof.

In a twenty-fourth aspect, in combination with the twenty-third aspect, the location includes an effective location of a receive antenna.

In a twenty-fifth aspect, in combination with the twenty-fourth aspect, the reference signal session includes an RF sensing session.

In a twenty-sixth aspect, in combination with the twenty-fifth aspect or the twenty-fifth aspect, the first reference signal includes a first sensing reference signal received from another network entity, and the second reference signal includes a second sensing reference signal received from the other network entity.

In a twenty-seventh aspect, in combination with one or more of the first aspect or the twenty-fifth aspect through the twenty-sixth aspect, the network entity includes a first transmission and reception point, and the other network entity includes a second transmission and reception point.

In a twenty-eighth aspect, in combination with one or more of the first aspect or the twenty-fifth aspect through the twenty-seventh aspect, the information indicates the location.

In a twenty-ninth aspect, in combination with one or more of the first aspect or the twenty-fifth aspect through the twenty-eighth aspect, the information is transmitted to a network.

In a thirtieth aspect, in combination with one or more of the seventeenth aspect through the twenty-ninth aspect, the techniques further include receiving index information that indicates multiple index values.

In a thirty-first aspect, in combination with the thirtieth aspect, each index value of the multiple index values is associated with an effective Rx location, an effective Tx location, or a combination thereof.

In a thirty-second aspect, in combination with the thirty-first aspect, wherein the information indicates the measurement value and the location.

In a thirty-third aspect, in combination with the thirty-second aspect, the information includes an index value of the multiple index values that indicates the location.

In one or more aspects, techniques for supporting reference signal resource reporting may include additional aspects, such as any single aspect or any combination of aspects described below or in connection with one or more other processes or devices described elsewhere herein. In a thirty-fourth aspect, techniques for supporting determining a measurement representative of a value measured by a combination of multiple reference signal resources may include transmitting, using a first antenna element of an antenna array of the network entity, a first sensing reference signal of a reference signal session. The techniques may further include transmitting, using a second antenna element of the antenna array of the network entity, a second sensing reference signal of the reference signal session. The techniques may also include transmitting, to a network, information that indicates a first location of the first antenna element, a second location of the second antenna element, an equivalent location based on the first location and the second location, or a combination thereof. In some examples, the techniques in the thirty-fourth aspect may be implemented in a method or process. In some other examples, the techniques of the thirty-fourth aspect may be implemented in a wireless communication device, which may include a network entity or a component of a network entity. For example, the techniques may include or correspond to a method of wireless communication performed by a network entity. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a thirty-fifth aspect, in combination with the thirty-fourth aspect, the network entity includes a first UE or a first transmission and reception point.

In a thirty-sixth aspect, in combination with the thirty-fourth aspect or the thirty-fifth aspect, the network includes a core network.

In a thirty-seventh aspect, in combination with one or more of the thirty-fourth aspect through the thirty-sixth aspect, the first sensing reference signal and the second sensing reference signal are transmitted to a second UE or a second transmission and reception point.

In a thirty-eighth aspect, in combination with one or more of the thirty-fourth aspect through the thirty-seventh aspect, the first location, the second location, the equivalent location, or a combination thereof, is with respect to a reference location on the network entity.

In a thirty-ninth aspect, in combination with one or more of the thirty-fourth aspect through the thirty-eighth aspect, the information indicates the first location and the second location.

In a fortieth aspect, in combination with one or more of the thirty-fourth aspect through the thirty-eighth aspect, the information indicates the equivalent location.

In a forty-first aspect, in combination with one or more of the thirty-fourth aspect through the fortieth aspect, the techniques further include receiving index information that indicates multiple index values.

In a forty-second aspect, in combination with the forty-first aspect, each index value of the multiple index values is associated with an effective Rx location, an effective Tx location, or a combination thereof.

In a forty-third aspect, in combination with the forty-second aspect, the information indicates the equivalent location.

In a forty-fourth aspect, in combination with the forty-third aspect, the information includes an index value of the multiple index values that indicates the equivalent location.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-7 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A. B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A network entity comprising:
a memory storing processor-readable code; and
at least one processor coupled to the memory, the at least one processor configured to execute the processor-readable code to cause the at least one processor to perform operations comprising:
receiving a first reference signal of a reference signal session;
receiving a second reference signal of the reference signal session; and
transmitting, based on the first reference signal and the second reference signal, information that indicates a measurement value, a location associated with an antenna array, or a combination thereof.

2. The network entity of claim 1, wherein:
the network entity includes a user equipment (UE) or a first transmission and reception point (TRP);
the reference signal session includes a positioning session or a radio frequency (RF) sensing session;
the first reference signal includes a first positioning reference signal from a first antenna element of another network entity, and the second reference signal includes a second positioning reference signal from a second antenna element of the other network entity;
the first positioning reference signal is associated with a first positioning reference signal ID that indicates a first location, and the second positioning reference signal is associated with a second positioning reference signal ID that indicates a second location;
the measurement value includes:
when the reference signal session includes the positioning session, an angle of arrive, a reference signal time difference (RSTD), a reference signal received power (RSRP), or a reference signal received quality (RSRQ); or
when the reference signal session includes the RF session, a range, an angle, or a Doppler map; or
a combination thereof.

3. The network entity of claim 1, wherein the operations further comprise:
measuring a channel to generate a first measurement value that is associated with the first reference signal;
measuring the channel to generate a second measurement value that is associated with the second reference signal; and
generating the measurement value based on the first measurement value and the second measurement value.

4. The network entity of claim 1, wherein:
the information indicates the measurement value;
the information indicates a technique used to generate the measurement value based on the first reference signal and the second reference signal; or
a combination thereof.

5. The network entity of claim 1, wherein:
the information indicates the measurement value; and
the information indicates the measurement value is based on the first reference signal and the second reference signal.

6. The network entity of claim 1, wherein the operations further comprise:
determining a first location of a first transmit antenna element of the antenna array, the first transmit antenna element associated with transmission of the first reference signal;
determining a second location of a second transmit antenna element of the antenna array, the second transmit antenna element associated with transmission of the second reference signal; and
determining the location based on the first location, the second location, or a combination thereof, wherein the location includes an effective location of a transmit antenna.

7. The network entity of claim 6, wherein the information indicates the measurement value and the location.

8. The network entity of claim 1, wherein the operations further comprise:
determining a first location of a first receive antenna element of the antenna array, the first receive antenna element associated with reception of the first reference signal;
determining a second location of a second receive antenna element of the antenna array, the second antenna receive element associated with reception of the second reference signal; and
determining the location based on the first location, the second location, or a combination thereof, wherein the location includes an effective location of a receive antenna.

9. The network entity of claim 1, wherein:
the reference signal session includes a radio frequency (RF) sensing session;
the first reference signal includes a first sensing reference signal received from another network entity, and the second reference signal includes a second sensing reference signal received from the other network entity;
the network entity includes a first transmission and reception point, and the other network entity includes a second transmission and reception point;
the information indicates the location;
the information is transmitted to a network; or
a combination thereof.

10. The network entity of claim 1, wherein the operations further comprise:
receiving index information that indicates multiple index values, each index value of the multiple index values is associated with an effective receive (Rx) location, an effective transmit (Tx) location, or a combination thereof, and
wherein the information indicates a measurement value and the location, the information includes an index value of the multiple index values that indicates the location.

11. A method of wireless communication performed by a network entity, the method comprising:
receiving a first reference signal of a reference signal session;
receiving a second reference signal of the reference signal session; and
transmitting, based on the first reference signal and the second reference signal, information that indicates a measurement value, a location associated with an antenna array, or a combination thereof.

12. The method of claim 11, wherein:
the network entity includes a user equipment (UE) or a first transmission and reception point (TRP);
the reference signal session includes a positioning session or a radio frequency (RF) sensing session;
the first reference signal includes a first positioning reference signal from a first antenna element of another network entity, and the second reference signal includes a second positioning reference signal from a second antenna element of the other network entity;
the first positioning reference signal is associated with a first positioning reference signal ID that indicates a first location, and the second positioning reference signal is associated with a second positioning reference signal ID that indicates a second location;
the measurement value includes:
when the reference signal session includes the positioning session, an angle of arrive, a reference signal time difference (RSTD), a reference signal received power (RSRP), or a reference signal received quality (RSRQ); or
when the reference signal session includes the RF session, a range, an angle, or a Doppler map; or
a combination thereof.

13. The method of claim 11, further comprising:
measuring a channel to generate a first measurement value that is associated with the first reference signal;
measuring the channel to generate a second measurement value that is associated with the second reference signal; and
generating the measurement value based on the first measurement value and the second measurement value.

14. The method of claim 11, wherein:
the information indicates the measurement value;
the information indicates a technique used to generate the measurement value based on the first reference signal and the second reference signal; or
a combination thereof.

15. The method of claim 11, wherein:
the information indicates the measurement value; and
the information indicates the measurement value is based on the first reference signal and the second reference signal.

16. The method of claim 11, further comprising:
determining a first location of a first transmit antenna element of the antenna array, the first transmit antenna element associated with transmission of the first reference signal;
determining a second location of a second transmit antenna element of the antenna array, the second transmit antenna element associated with transmission of the second reference signal; and
determining the location based on the first location, the second location, or a combination thereof, wherein the location includes an effective location of a transmit antenna.

17. The method of claim 16, wherein the information indicates the measurement value and the location.

18. The method of claim 11, further comprising:
determining a first location of a first receive antenna element of the antenna array, the first receive antenna element associated with reception of the first reference signal;
determining a second location of a second receive antenna element of the antenna array, the second antenna receive element associated with reception of the second reference signal; and
determining the location based on the first location, the second location, or a combination thereof, wherein the location includes an effective location of a receive antenna.

19. The method of claim 11, wherein:
the reference signal session includes a radio frequency (RF) sensing session;
the first reference signal includes a first sensing reference signal received from another network entity, and the second reference signal includes a second sensing reference signal received from the other network entity;
the network entity includes a first transmission and reception point, and the other network entity includes a second transmission and reception point;
the information indicates the location;
the information is transmitted to a network; or
a combination thereof.

20. The method of claim 11, further comprising:
receiving index information that indicates multiple index values, each index value of the multiple index values is associated with an effective receive (Rx) location, an effective transmit (Tx) location, or a combination thereof, and
wherein the information indicates a measurement value and the location, the information includes an index value of the multiple index values that indicates the location.

21. A network entity comprising:
a memory storing processor-readable code; and
at least one processor coupled to the memory, the at least one processor configured to execute the processor-readable code to cause the at least one processor to perform operations comprising:
transmitting, using a first antenna element of an antenna array of the network entity, a first sensing reference signal of a reference signal session;
transmitting, using a second antenna element of the antenna array of the network entity, a second sensing reference signal of the reference signal session; and
transmitting, to a network, information that indicates a first location of the first antenna element, a second location of the second antenna element, an equivalent location based on the first location and the second location, or a combination thereof.

22. The network entity of claim 21, wherein:
the network entity includes a first user equipment (UE) or a first transmission and reception point;
the network includes a core network;
the first sensing reference signal and the second sensing reference signal are transmitted to a second UE or a second transmission and reception point;
the first location, the second location, the equivalent location, or a combination thereof, is with respect to a reference location on the network entity; or
a combination thereof.

23. The network entity of claim 21, wherein the information indicates the first location and the second location.

24. The network entity of claim 21, wherein the information indicates the equivalent location.

25. The network entity of claim 21, wherein the operations further comprise:
receiving index information that indicates multiple index values, each index value of the multiple index values is associated with an effective receive (Rx) location, an effective transmit (Tx) location, or a combination thereof, and
wherein the information indicates the equivalent location, the information includes an index value of the multiple index values that indicates the equivalent location.

26. A method of wireless communication performed by a network entity, the method comprising:
transmitting, using a first antenna element of an antenna array of the network entity, a first sensing reference signal of a reference signal session;
transmitting, using a second antenna element of the antenna array of the network entity, a second sensing reference signal of the reference signal session; and
transmitting, to a network, information that indicates a first location of the first antenna element, a second location of the second antenna element, an equivalent location based on the first location and the second location, or a combination thereof.

27. The method of claim 26, wherein:
the network entity includes a first user equipment (UE) or a first transmission and reception point;
the network includes a core network;
the first sensing reference signal and the second sensing reference signal are transmitted to a second UE or a second transmission and reception point;
the first location, the second location, the equivalent location, or a combination thereof, is with respect to a reference location on the network entity; or
a combination thereof.

28. The method of claim 26, wherein the information indicates the first location and the second location.

29. The method of claim 26, wherein the information indicates the equivalent location.

30. The method of claim 26, further comprising:
receiving index information that indicates multiple index values, each index value of the multiple index values is associated with an effective receive (Rx) location, an effective transmit (Tx) location, or a combination thereof, and
wherein the information indicates the equivalent location, the information includes an index value of the multiple index values that indicates the equivalent location.
